(19) United States
(12) Patent Application Publication
(10) Pub. No.: US 2025/0192908 A1
(43) Pub. Date: Jun. 12, 2025

(54) CONCEPTS FOR A DIGITAL RADIO SIGNAL

(71) Applicant: Fraunhofer-Gesellschaft zur Förderung der angewandten Forschung e.V., München (DE)

(72) Inventors: Markus PROSCH, Erlangen (DE); Olaf KORTE, Erlangen (DE); Alexander ZINK, Erlangen (DE)

(73) Assignee: Fraunhofer-Gesellschaft zur Förderung der angewandten Forschung e.V., München (DE)

(21) Appl. No.: 19/049,957

(22) Filed: Feb. 10, 2025

Related U.S. Application Data
(63) Continuation of application No. PCT/EP2023/071212, filed on Jul. 31, 2023.

(30) Foreign Application Priority Data
Aug. 9, 2022 (DE) 10 2022 208 300.8

(51) Int. Cl. H04H 40/18

(52) U.S. Cl. CPC H04H 40/18

(57) ABSTRACT

A digital radio signal having a first channel for carrying side information, and a second channel for carrying content information, has, in the first channel, an alarm status indication, which indicates whether an alarm announcement is active or inactive. A further, digital radio signal has content information, and a target group information, which indicates a geographical region for which the content information is dedicated, wherein the target group information is indicative of at least three geographical positions forming a polygon to indicate the geographical region, wherein the at least three geographical positions are coded into the digital radio signal using differential coding.

### CROSS-REFERENCE TO RELATED APPLICATIONS

This application is a continuation of copending International Application No. PCT/EP2023/071212, filed Jul. 31, 2023, which is incorporated herein by reference in its entirety, and additionally claims priority from German Application No. 10 2022 208 300.8, filed Aug. 9, 2022, which is also incorporated herein by reference in its entirety.

### TECHNICAL FIELD

Embodiments of the present disclosure are related to digital radio signal, e.g., a Digital Audio Broadcating (DAB) signal or DAB+signal or a Digital Radio Mondiale (DRM) signal, receivers for receiving digital radio signals, apparatuses for providing digital radio signals, and methods for receiving or providing digital radio signals.

### BACKGROUND OF THE INVENTION

In the broadcasting of digital radio signals, such as DAB or DAB+signals, information may be transmitted which relates to specific situations or specific target groups. For example, digital radio signals may be used to warn the population during emergency situations. For example, in DAB, an alarm announcement may be signaled, in a fast information group (FIG), FIG. 0/19 or FIG. 0/26. Such information is sent while alarm announcements are active, so that receivers receiving the information may switch to a service, which is dedicated to alarm announcements. Furthermore, information signaled via digital radio signals, such as said alarm announcements, but also other information or content, may be dedicated for a specific target group of receivers. For example, a target group may be defined by a geographical region.

It is desirable to have a concept for digital radio signals, which concept allows a reliable and precise notification of a receiver about an alarm announcement at a low power consumption of the receiver, and/or which concept allows an efficient signaling of a geographical region indicating a target group of an information, e.g. efficient in terms of required bandwidth/data rate.

### SUMMARY

An embodiment may have an apparatus for receiving a digital radio signal, the digital radio signal having a first channel for carrying side information, and a second channel for carrying content information, the apparatus being configured for deriving, from the first channel, an alarm status indication, which indicates whether an alarm announcement is active or inactive.

Another embodiment may have an apparatus for receiving a digital radio signal, configured for deriving, from the digital radio signal, a target group information which indicates a geographical region, comparing an information about a geographic location of the apparatus with the target group information to determine whether the apparatus is, according to the information about a geographic location, located within the geographical region, if the apparatus is, according to the information about a geographic location, located within the geographical region, refraining from processing a content information signaled in the digital radio signal, wherein the target group information is indicative of at least three geographical positions forming a polygon to indicate the geographical region, wherein the apparatus is configured for using differential decoding for deriving the geographical positions from the target group information.

Another embodiment may have an apparatus for providing a digital radio signal, the digital radio signal having a first channel for carrying side information, and a second channel for carrying content information, the apparatus being configured for providing, in the first channel, an alarm status indication, which indicates whether an alarm announcement is active or inactive.

Another embodiment may have an apparatus for providing a digital radio signal, configured for providing, in the digital radio signal, content information, and a target group information, which indicates a geographical region for which the content information is dedicated, wherein the target group information is indicative of at least three geographical positions forming a polygon to indicate the geographical region, wherein the apparatus is configured for using differential coding for providing the geographical positions in the target group information.

According to another embodiment, a method for receiving a digital radio signal, so that the digital radio signal has a first channel for carrying side information, and a second channel for carrying content information, may have the step of: deriving, from the first channel, an alarm status indication, which indicates whether an alarm announcement is active or inactive.

According to another embodiment, a method for receiving a digital radio signal may have the step of: deriving, from the digital radio signal, a target group information which indicates a geographical region, comparing an information about a geographic location with the target group information to determine whether the geographic location is, according to the information about a geographic location, located within the geographical region, and if the geographic location is, according to the information about a geographic location, located within the geographical region, refraining from processing a content information signaled in the digital radio signal, wherein the target group information is indicative of at least three geographical positions forming a polygon to indicate the geographical region, wherein the method has using differential decoding for deriving the geographical positions from the target group information.

According to another embodiment, a method for providing a digital radio signal so that the digital radio signal has a first channel for carrying side information, and a second channel for carrying content information, may have the step of: providing, in the first channel, an alarm status indication, which indicates whether an alarm announcement is active or inactive.

According to another embodiment, a method for providing a digital radio signal may have the step of: providing, in the digital radio signal, content information, and a target group information, which indicates a geographical region for which the content information is dedicated, wherein the target group information is indicative of at least three geographical positions forming a polygon to indicate the geographical region, wherein the method has using differential coding for providing the geographical positions in the target group information.

Another embodiment may have a non-transitory digital storage medium having a computer program stored thereon to perform the method of any of the above methods according to the invention when said computer program is run by a computer.

According to another embodiment, a digital radio signal may have: a first channel for carrying side information, and a second channel for carrying content information, wherein the first channel has an alarm status indication, which indicates whether an alarm announcement is active or inactive.

According to another embodiment, a digital radio signal may have: content information, and a target group information, which indicates a geographical region for which the content information is dedicated, wherein the target group information is indicative of at least three geographical positions forming a polygon to indicate the geographical region, wherein the at least three geographical positions are coded into the digital radio signal using differential coding.

Embodiments of the present invention rely on the idea to signal in a first channel of a digital radio signal, an alarm status indication which indicates, whether an alarm announcement is active or inactive. Explicitly signaling, if the alarm announcement is inactive, allows a receiver rapidly recognizing the status of the alarm announcement. For example, the receiver does not need to search for an alarm announcement for an unnecessary long time. For example, compared to implementations which merely signal active alarm announcements, in which receivers may search until receiving an active alarm announcement or until a certain search time has lapsed, the herein presented signalization allows a receiver stop searching immediately after having received the alarm status indication, such allowing a short search period in particular in the most frequent scenario that no alarm announcement is active.

Accordingly, embodiments of the present invention provide an apparatus for receiving a digital radio signal, the digital radio signal comprising a first channel for carrying side information, and a second channel for carrying content information, the apparatus being configured for deriving, from the first channel, an alarm status indication, which indicates whether an alarm announcement is active or inactive. For example, the alarm status indication may indicate whether an alarm announcement is active or whether no alarm announcement is active, i.e. all of a set of alarm announcements of different types, including the alarm announcement, are inactive.

Further embodiments of the present invention rely on the idea that a good tradeoff between the signaling of a precise geographic region and a small amount of data required for the signaling may be achieved by indicating the geographic region in form of a polygon defined by at least three geographic positions, and signaling the geographic positions using differential coding.

Accordingly, further embodiments of the present invention provide an apparatus for receiving a digital radio signal, configured for deriving, from the digital radio signal, a target group information which indicates a geographical region, and configured for comparing an information about a geographic location of the apparatus with the target group information to determine whether the apparatus is, according to the information about a geographic location, located within the geographical region. The apparatus is configured for refraining from processing a content information signaled in the digital radio signal, if the apparatus is, according to the information about a geographic location, not located within the geographical region. For example, otherwise, the apparatus processes, or consider processing, the content information. The target group information is indicative of at least three geographical positions forming a polygon to indicate the geographical region, wherein the apparatus is configured for using differential decoding for deriving the geographical positions from the target group information. For example, at least two of the at least three geographic positions may be encoded into the digital radio signal differentially with respect to a reference position, e.g., a predetermined position among the at least three positions, or a previous position according to a coding order among the positions. That is, the position may be indicated relative to the reference position.

Further embodiments of the present invention provide an apparatus for providing a digital radio signal, the digital radio signal comprising a first channel for carrying side information, and a second channel for carrying content information, the apparatus being configured for providing, in the first channel, an alarm status indication, which indicates whether an alarm announcement is active or inactive.

Further embodiments of the present invention provide an apparatus for providing a digital radio signal, configured for providing, in the digital radio signal, content information, and a target group information, which target group information indicates a geographical region for which the content information is dedicated. The target group information is indicative of at least three geographical positions forming a polygon to indicate the geographical region, wherein the apparatus is configured for using differential coding for providing the geographical positions in the target group information.

Further embodiments of the present invention provide a method for receiving a digital radio signal, so that the digital radio signal comprises a first channel for carrying side information, and a second channel for carrying content information, the method comprising: deriving, from the first channel, an alarm status indication, which indicates whether an alarm announcement is active or inactive.

Further embodiments of the present invention provide a method for receiving a digital radio signal, comprising: deriving, from the digital radio signal, a target group information which indicates a geographical region; comparing an information about a geographic location with the target group information to determine whether the geographic location is, according to the information about a geographic location, located within the geographical region; if the geographic location is, according to the information about a geographic location, located within the geographical region, refraining from processing a content information signaled in the digital radio signal. The target group information is indicative of at least three geographical positions forming a polygon to indicate the geographical region, wherein the method comprises using differential decoding for deriving the geographical positions from the target group information.

Further embodiments of the present invention provide a method for providing a digital radio signal so that the digital radio signal comprises a first channel for carrying side information, and a second channel for carrying content information, the method comprising: providing, in the first channel, an alarm status indication, which indicates whether an alarm announcement is active or inactive.

Further embodiments of the present invention provide a method for providing a digital radio signal, the method comprising: providing, in the digital radio signal, content information, and a target group information, which indicates a geographical region for which the content information is dedicated. The target group information is indicative of at least three geographical positions forming a polygon to indicate the geographical region, wherein the method comprises using differential coding for providing the geographical positions in the target group information.

Further embodiments of the present invention provide a computer program for implementing any of the above-mentioned methods, when being executed on a computer or a signal processor.

Further embodiments of the present invention provide digital radio signals provided by any of the above-mentioned methods.

### BRIEF DESCRIPTION OF THE DRAWINGS

Embodiments of the present disclosure are described in more detail below with respect to the figures, among which:

FIG. 1 illustrates an apparatus for receiving a digital radio signal according to an embodiment;

FIG. 2 illustrates an apparatus for providing a digital radio signal according to an embodiment;

FIG. 3 illustrates digital radio signal according to an embodiment;

FIG. 4 illustrates an implementation of the first channel according to an embodiment;

FIG. 5 illustrates an indication of a circular geographical region according to an embodiment;

FIG. 6 illustrates an indication of a polygonal geographical region according to an embodiment;

FIG. 7 shows a flow-chart for an operation scheme of the receiver according to an embodiment;

FIG. 8 shows a further flow-chart for an operation scheme of the receiver according to an embodiment;

FIG. 9 shows a further flow-chart for an operation scheme of the receiver according to an embodiment;

FIG. 10 illustrates an apparatus for receiving a digital radio signal according to another embodiment; and

FIG. 11 illustrates an apparatus for providing a digital radio signal according to another embodiment.

### DETAILED DESCRIPTION OF THE INVENTION

Embodiments of the present invention are now described in more detail with reference to the accompanying drawings, in which the same or similar elements or elements that have the same or similar functionality have the same reference signs assigned or are identified with the same name. In the following description, a plurality of details is set forth to provide a thorough explanation of embodiments of the disclosure. However, it will be apparent to one skilled in the art that other embodiments may be implemented without these specific details. In addition, features of the different embodiments described herein may be combined with each other, unless specifically noted otherwise.

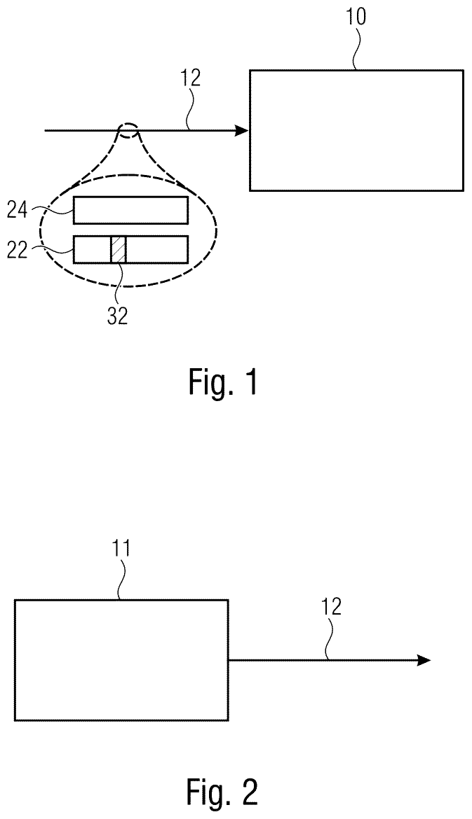

FIG. 1 illustrates an apparatus 10 for receiving a digital radio signal 12 according to an embodiment. Apparatus 10 may also be referred to as a receiver 10. For example, receiver 10 may be a DAB or a DAB+receiver, for example according to version ETSI EN 300 401 V2.1.1 (2017-01) of DAB or DAB+. In alternative examples, the receiver may be a DRM receiver. The digital radio signal 12 comprises a first channel 22 for carrying side information, for example status information, service information, and/or configuration information. For example, in cases in which the receiver 10 is DAB or a DAB+receiver the first channel may correspond to the fast information channel, FIC. The digital radio signal further comprises a second channel 24 for carrying content information, e.g., information for presentation, e.g., audio information and/or text information. In examples, in which the receiver 10 is DAB or a DAB+receiver, the second channel may correspond to the main service channel, MSC. Receiver 10 is configured for deriving an alarm status indication 32 from the first channel 22. The alarm status indication 32 indicates whether an alarm announcement is active or inactive. For example, the receiver 10 may check, whether the alarm status indication indicates that the alarm announcement is active or whether the alarm status indication indicates that the alarm announcement is inactive. For example, the alarm status indication indicates whether one of a set of alarm announcements is active, or whether no alarm announcement is active, i.e. all alarm announcements of the set are inactive.

For example, apparatus 10 receive the digital radio signal 12 via an antenna, or via cable, or via the Internet. In examples, apparatus 10 may comprise means such as an antenna and/or a demultiplexer for receiving the digital radio signal.

For example, the digital radio signal may signal, or comprise, an ensemble of services, the content of which is carried in the second channel. For example, the digital radio signal may refer to a frequency band signaling an ensemble of services. For example, the digital radio signal 12 may refer to one DAB or DAB+band.

For example, the first channel 22 comprises information, which is used for retrieving the content information from the second channel 24. For example, receiver 10 may derive information from the first channel 22, and may use this information for deriving content information from the second channel 32. For example, the information may refer to information of how to demultiplex or how to deinterleave information of the second channel 24.

For example, the second channel 24 may be time interleaved, whereas the first channel 22 may be non-time interleaved.

In other words, the first channel may be easily accessible for receiver 10, e.g. without the need of further information, e.g. for deinterleaving the packets of the first channel. Therefore, the information in the first channel may be quickly available, and accessing the information in the first channel may consume little power. Furthermore, the first channel, e.g., FIC in DAB, may be particularly safe against transmission losses, such providing for a reliable signalization of the alarm status indication.

FIG. 2 illustrates an apparatus 11 for providing a digital radio signal 12 according to an embodiment. The digital radio signal 12 provided by apparatus 11 may correspond to the digital radio signal 12 as described with respect to the receiver 10 of FIG. 1. Accordingly, apparatus 11 is configured for providing the alarm status indication 32 in the first channel 22.

For example, apparatus 11 provides the digital radio signal via an antenna, or via cable, or via the Internet. In examples, apparatus 11 may comprise means such as an antenna and/or a multiplexer for providing the digital radio signal, e.g., a DAB or DAB+multiplexer. In alternative examples, the apparatus may be a DRM multiplexer.

In the following, optional details and implementations of a digital radio signal 12 as well as the receiver 10 of FIG. 1 will be described. Features described with respect to the digital radio signal 12 may also be understood as features of the apparatus 11 in a sense that apparatus 11 is configured for providing the digital radio signal 12. Similarly, if it is described that the receiver 10 derives a piece of information from the digital radio signal 12, it is to be understood that the digital radio signal 12 comprises an indication for this piece of information, and that the apparatus 11 provides this piece of information in the digital radio signal 12.

For example, the alarm status indication may refer to data included in the digital radio signal 12, which data indicates, whether or not an alarm situation, or an emergency situation, is present, i.e., active. The alarm announcement may refer to a signalization of an alarm situation in the digital radio signal, any may further be related to content information about the alarm situation. For example, an alarm announcement being active, may imply that there is further information signaled in the digital radio signal, which specifies the alarm and/or that there is content information present. For example, the digital radio signal 12 may include a service using which information about, or an announcement of, an emergency situation may be broadcasted. Upon receiving an active alarm status indication, receiver 10 may be aware of whether or not an alarm announcement is presently active. If so, receiver 10 may automatically tune into the service broadcasting the information about the emergency situation. For example, the first channel may comprises information about the service carrying a content of an active alarm announcement. For example, receiver 10 may retrieve a content related to the alarm announcement from the second channel 24, and may provide the content for presentation, e.g., to an audio output or a display output. Alternatively, the digital radio signal may comprise, in case of an active alarm announcement, an indication which indicates where the content is carried. This indication may indicated a service of the digital radio signal, or may indicate a service of another digital radio signal. Accordingly, the content related to the alarm announcement is not necessarily carried in the digital radio signal itself.

Furthermore, the decision of whether or not provide the content related to the alarm announcement may, in examples, depend on further conditions, which will be described below, such as whether the receiver 10 belongs to a target group of the alarm announcement and/or whether or not a currently broadcasted version of the alarm announcement was already acknowledged, e.g., by a user, and/or on a type of the alarm announcement. Accordingly, the above-mentioned processing of the alarm announcement may include further steps being performed by receiver 10 to decide whether or not to derive the content related to the alarm announcement and providing the content for being output.

As described with respect to FIG. 1, the alarm status indication indicates whether an alarm announcement is active or inactive. Accordingly, once receiver 10 retrieved the alarm status indication 32 from the digital radio signal, e.g., by finding the predetermined packet 36 and retrieving the alarm status indication 32 therefrom, receiver 10 may be aware of information which is definitive of both situations, the alarm being active or inactive. Compared to implementations, in which a signalization of the presence of an alarm situation is merely broadcasted, when an alarm situation is present, signaling whether the alarm announcement is active or inactive avoids the uncertainty of not knowing whether there is an active alarm announcement in case no indication has been received. In other words, in case of packets being lost in transmission, receiver 10 does not falsely interpret the circumstance of not having received an alarm announcement as a scenario of no alarm being present. For example, in a standby mode, receiver 10 may periodically check whether an alarm announcement is active or inactive. After having received the alarm status indication, receiver 10 may switch off to standby mode again instead of having to search the digital radio signal 12 permanently in order not to miss an alarm announcement.

In other words, the alarm status indication 32 may comprise an indicator having a first state and a second state, the first state indicating that the alarm announcement is active, and the second state indicating that the alarm announcement is inactive.

As already mentioned, the alarm announcement may have a related content being signaled in the second channel. In particular, the content related to the alarm announcement may be carried in a predetermined service component, e.g., “an audio service component/stream, of the second channel. Alternatively, the content related to the alarm announcement may be carried in a predetermined service component of a further digital radio signal. For example, the alarm announcement may refer to a service which is provided in another digital radio signal, for example, another DAB band. In such cases, upon deciding to derive the content related to the alarm announcement, receiver 10 may switch to another digital radio signal so as to derive the content related to the alarm announcement.

According to embodiments, receiver 10 is configured for processing the alarm announcement if the alarm status indication 32 indicates that the alarm announcement is active. Otherwise, that is, if the alarm status indication indicates that the alarm announcement is inactive, receiver 10 may refrain from processing, or suppress a processing of, the alarm status and notification.

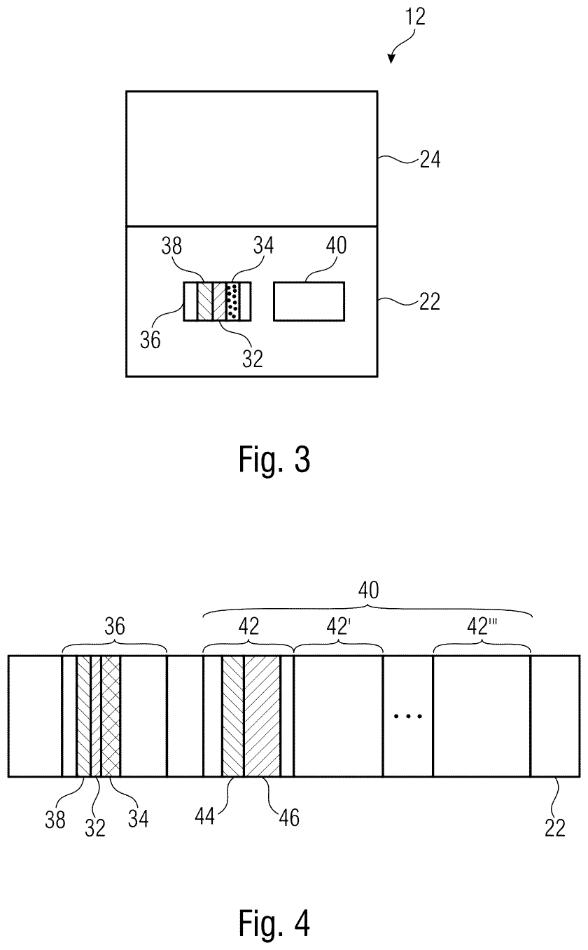

FIG. 3 illustrates an example of the digital radio signal 12 according to embodiments of receiver 10 and apparatus 11 of FIG. 1 and FIG. 2. According to the example of FIG. 3, the digital radio signal 12 includes, in the first channel 22, a predetermined packet 36. For example, the packet may refer to a fast information group, FIG, of DAB. For example, the predetermined packet 36 may be implemented as described below with respect to FIG. S.

According to the example of FIG. 3, the alarm status indication 32 is included in the predetermined packet 36, and receiver 10 retrieves the alarm status indication 32 from the predetermined packet 36.

For example, the predetermined packet 36 comprises an identifier, which identifies the predetermined packet. For example, receiver 10 may scan the first channel 22 to search for the predetermined packet 36, for example, by scanning headers of packets included in the first channel, the headers of the packets including identifiers for the packets. After identifying the predetermined packet 36, apparatus 10 may retrieve the alarm status indication 36 from the predetermined packet.

Continuing the description of FIG. 1, the details described in the following are independent of the features of FIG. 3, but may optionally be combined with the features of FIG. 3.

According to embodiments, the alarm status indication 32 refers to one of a set of alarm types. The alarm status indication 32 may be indicative of the alarm type, to which the alarm status indication refers. For example, e.g. as in the exemplary implementation of FIG. S described below, the alarm status indication 32 comprises respective alarm status indicators for each alarm type of the set of alarm types. For example, the predetermined packet 36 may comprise 1 bit for each of the alarm types, e.g., bits A, B, C, D. In examples, at most one of the alarm status indicators in the first channel may have a status, which indicates that the alarm announcement related to the respective alarm status indicator is active. In other words, the first channel, or the predetermined packet 36, may indicate either that all alarm types are inactive, or may indicate exactly one alarm type as being active, the one alarm type being active being the one to which the alarm announcement refers, i.e., being the one to which further information or data about the alarm announcement is related.

In other words, the alarm status indication 32 may differentiate between the alarm announcement being inactive, i.e. all of a set of alarm types being inactive, and one of the set of alarm types being active. In the latter case, the alarm status indication may further indicate, which of the alarm types is active, i.e. the type of the currently active announcement.

For example, the alarm types may differentiate between alarm announcements, the content of which is included in the second channel of the digital radio signal, i.e. the same digital radio signal from which the alarm status indication 32 is derived, and an alarm announcement, the content of which is carried in another digital radio signal, requiring a switching of the digital radio signal for retrieving the content related to the alarm announcement. The latter alarm type may be referred to as an OE alarm. For example, in case of the digital radio signal being a DRM signal, Automatic Frequency Switching (AFS) may be used for switching frequencies.

Additionally or alternatively, the alarm types may optionally differentiate between real alarms and test alarms. For example, if the alarm announcement is of a test type, i.e., the alarm type of the alarm announcement refers to a test alarm, receiver 10 may process the alarm announcement merely if a setting, or a configuration information, indicates that the receiver 10 show process alarm announcements of the test type. For example, the setting or the configuration information may be stored in receiver 10, or may be a setting, which may be changed by a user of the receiver 10. In other words, the apparatus 10 may process the alarm announcement of the test type, if the configuration indication indicates the process alarm announcements of a test type, and apparatus 10 may suppress, or refrain from, the processing of the alarm announcement if the configuration indication indicates not to process, or to suppress, alarm announcements of test types. Accordingly, the set of alarm types may comprise four different alarm types, differing by being an alarm type of test type, of OE test type, real alarm type or OE real alarm type.

According to embodiments, the first channel further comprises an indication 38, e.g., referred to as referred to as a support indication 38, which indicates whether the digital radio signal 12 supports a signalization of the alarm status indication. For example, the first channel comprises, for each alarm type of the set of alarm types, an indication, which indicates whether the digital radio signal supports a signalization of the respective alarm status indication.

For example, the support indication, or the respective support indications, may be signaled in the predetermined packet 36.

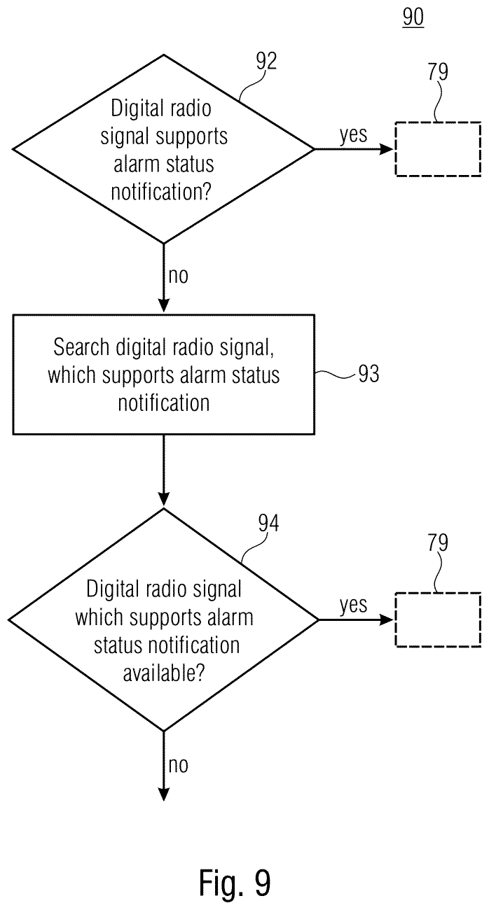

Signaling the support of the alarm status indication allows the receiver 10 to recognize whether or not an alarm status indication will be signaled in the digital radio signal. Accordingly, in case that the digital radio signal does not support alarm status indications for any type of alarm announcements, to which the receiver shall react according to a setting of the receiver, receiver 10 may, for example, in a standby mode, refrain from searching for an alarm status indication. Accordingly, the receiver may save power. Additionally or alternatively, the receiver 10 may search, before switching to a standby-mode, for a digital radio signal, which supports alarm status indications, so that receiver 10 may receive an alarm status indication 32 when searching. Additionally or alternatively, the receiver 10 may notify a user that the currently received digital radio signal does not support alarm status indications, so that the user may react by switching to another signal. Accordingly, the signaling of the support indication may provide for reliability of the alarm announcement, so that either the receiver, or the user, may take action to make sure to receive alarm announcements. An exemplary scheme for exploiting the support indication by the receiver 10 is described with respect to FIG. 9.

For example, the predetermined packet 36 may comprise the alarm status indication 32, and the support indication 36. Accordingly, the predetermined packet, e.g., the FIG. of DAB, allows to precisely signal, which alarm announcement types are currently supported and their current switching status.

As illustrated in FIG. 3, according to embodiments, the first channel further comprises a revision indicator 34, which indicates a version of a content associated with alarm announcement. It is noted that the revision indicator 34 is independent of further features illustrated in FIG. 3, such as the support indication 38, the target group information 40.

In examples, the revision indicator 34 is signaled in the predetermined packet 36, as shown in FIG. 3.

For example, the revision indicator 34 may indicate a counter, which is incremented, e.g. by apparatus 11 for providing the digital audio signal, if the content associated with an active alarm announcement is updated. For example, the revision indicator 34 may explicitly refer to one of the set of alarm types, i.e., the version indicated by the revision indicator may refer to one of the alarm types, namely the one identified by the alarm status indicator 32 to be active. In other words, apparatus 11 may increment the counter, if the content associated with the active alarm announcement is updated with respect to a previous version for the same alarm type. For example, the counter may start at a predetermined value, e.g., zero, and may be reset to the predetermined value if the counter exceeds a further predetermined value.

For example, receiver 10 may store the version indicated by the revision indicator 34 of the predetermined packet 36, if the alarm status indication 32 of the predetermined packet 36 indicates alarm announcement. When receiving a subsequent packet of the type of the predetermined packet 36, receiver 10 may check the version indicated by the revision indicator signaled in the further predetermined packet to determine whether the version of the content associated with the active alarm announcement has changed. The receiver 10 may selectively process the alarm announcement in dependence on whether the version of the content has changed with respect to a previous version. For example, when the content associated with an alarm announcement has been presented for a certain time period, or if a user has acknowledged the alarm announcement, e.g., via a user input, receiver 10 may terminate providing the content associated with the alarm announcement, e.g., by going to a standby mode, or by proceeding with presenting a different surface. In such cases, receiver 10 may suppress a processing of an alarm announcement, if the version of the content associated with the alarm announcement has not changed with respect to the already acknowledged, or already presented, content. Otherwise, i.e., if the revision indicator 34 indicates that the version of the content has changed, receiver 10 may continue processing the alarm announcement.

Accordingly, signaling the revision indication 34 allows differentiating between different, e.g., successive, alarm announcements. In particular, signaling the version allows such differentiation even in case of transmission gaps.

In the following, an exemplary implementation of an FIG, referred to as FIG. S, as it may be used in the context DAB/DAB+, is described. FIG. S may optionally be an example of the predetermined packet 36.

FIG. S may be used to precisely signal, which alarm announcement types are currently supported, and their switching status. It also signals whether new announcement content is provided, i.e., a receiver should again react to the announcement.

FIG. S carries, for example, a payload of two bytes abcd ABCD rrrr XXXX

Where, for example:
a: announcement support alarm announcement
b: announcement support OE alarm announcement
c: announcement support test alarm announcement
d: announcement support OE test alarm announcement

A: announcement switching alarm announcement
B: announcement switching OE alarm announcement
C: announcement switching test alarm announcement
D: announcement switching OE test alarm announcement
rrrr: announcement revision count
XXXX: rfa (reserved for future addition)
a and b may only be set to 1 if FIG. 0/0 signals alarm announcement support.

Any number of bits of a, b, c, d may be set to 1, to indicate all types of supported announcements.

A maximum of one bit of A, B, C, D may be set to 1 at any time.

If any bit of A, B, C, D is set to 1, rrrr indicates the revision count of this announcement type (otherwise the value of rrrr shall be 0000). If an announcement of this type is enabled, this value is incremented by 1 modulo 16. This value can be used by the receiver to distinguish an ongoing announcement (including content updates referring to the same incident) from new announcement content (indicating a new/additional incident).

In FIG. S, Bits a to d may correspond to the support indication 38, bits A to D may correspond to the alarm status indication 32, and bits r may correspond to the revision indicator 34.

It is noted, that in the description of FIG. S, implementation details such as the exact number of bits of the described fields, and the order of the fields are exemplarily, and alternatively be implemented differently. Also, the fields may in examples be implemented independently from each other. Furthermore, the label “S” used for the described FIG. is merely exemplarily, other labels may be used.

According to examples, the predetermined packet 36 is continuously signaled in the digital radio signal 12, e.g., the predetermined packet 36 is periodically signaled in the digital radio signal 12, e.g., once per second (repetition rate B).

Continuing with the description of the implementations described with respect to FIG. 1 to FIG. 3, according to embodiments, the digital radio signal 12 further comprises a target group information 40, as illustrated in FIG. 3. It is noted, that the presence of the status indication 38, the revision indication 34, and the target group information group 40 in the digital radio signal 12 are independent from each other although they are jointly illustrated in FIG. 3. For example, the target group information 40 may be signaled in a further predetermined packet, which may, for example, follow the predetermined packet 36 in the first channel.

That is, the target group information 40 may be signaled in the first channel 22. However, in other examples, the target group information 40 may be signaled in the second channel 24.

The target group information indicates a property for specifying a target group of the alarm announcement. For example, receiver 10 is to be considered being part of the target group, if the property indicated by the target group information applies to receiver 10. For example, the property may be a geographic location, or a device type. Further examples of the property may be a setting using which receiver 10 is configured, or a status of receiver 10.

Thus, according to embodiments receiver 10 is configured for deriving the target group information 40 from the digital radio signal if the alarm status indication 32 indicates that the alarm announcement is active, e.g., that there is an active alarm for one of the alarm types. In other words, the target group information may refer to the alarm announcement in the sense, that the target group information specifies a target group of an active alarm announcement. For example, receiver 10 may retrieve the target group information 40 from a further predetermined packet, e.g. FIG. R described later on, which may optionally be part of the first channel 22.

For example, receiver 10 compares the target group information 40 to an information about the receiver 10 (e.g. an information about a property, or a geographic location, or a status of receiver 10). For example, the information about the receiver 10 may be stored in a storage medium of the receiver 10, or may be provided by a module of the receiver 10, e.g., a module for determining the geographic location of receiver 10, e.g., via GPS or similar systems. By comparing the target group information to the information about the apparatus, receiver 10 may determine whether receiver 10 belongs to the target group of the active alarm announcement or not. Receiver 10 may selectively process the alarm announcement, if receiver 10 belongs to the target group of the alarm announcement. That is, receiver 10 may suppress the processing of the alarm announcement if receiver 10 does not belong to the target group of the alarm announcement.

For example, the target group may be defined by means of a geographical region to which the alarm announcement relates. In other words, the receiver 10 may belong to the target group, if it is located within the geographical region indicated by the target group information.

FIG. 4 illustrates an implementation of the first channel 22 according to an embodiment. According to this embodiment, the first channel 22 comprises the predetermined packet 36, e.g., as described with respect to FIG. 3 (indications 38 and 34 are optional), and further comprising the target group information 40. For example, the target group information 40 may be signaled using one or more packets 42, referred to using reference signs 42, 42′, . . . ,42′″ in FIG. 4. For example, the packets 42 may be FIGS. In other words, the target group information may be distributed onto one or more packets or FIGS. To this end, each of the packets 42 may optionally comprise an index indication 44, which identifies the respective packet 42 within the set of packets onto which the target group information 40 is distributed. Additionally, each of the packets 42 may optionally comprise an indication 46 of the total number of packets onto which the target group information 40 is distributed.

For example, each of the packets 42 may be implemented as described with respect to FIG R below wherein the information about the property which defines the target group may be signaled in the variable size area field.

Continuing the description of FIGS. 1 to 3, the details described in the following are independent of the features of FIG. 4, but may optionally be combined with the features of FIG. 4.

According to embodiments, the target group information indicates the geographical region based on a region code. For example, the region code may be signaled using a string. For example, the region code defines a geographical region, as defined by an authority within a country. For example, the region code is postal code, or a phone area code.

For example, string codes used for signaling the regional code may be hierarchical, so that a sub-string of a string, which sub-string comprises a number of hierarchically highest positioned characters of the string represents a region entirely comprising a region represented by the string. For example, the hierarchical levels may be defined by positions in the string. Receiver 10 may compare one or more region codes stored in the receiver to the one or more region codes signaled in the target group information 40 to determine whether the receiver belongs to the target group. To this end, receiver may compare the string of the region codes up to a hierarchical level of the region code indicated in the target group information 40, and if the strings match up to this level, receiver 10 may conclude that the receiver belongs to the target group, e.g. as described with respect to FIG. R.

According to embodiments, the implementation of the target group information allows signaling the geographical region using multiple region codes. Accordingly, the geographical region may be composed of multiple partial regions indicated by the multiple region codes. For example, the partial regions may be indicated to define geographical regions to which the alarm announcement applies, and geographical regions to which the alarm announcement does not apply. In other words, some regions may be included, and others may be excluded.

According to alternative embodiments, the target group information 40 indicates the geographical region based on geographical coordinates.

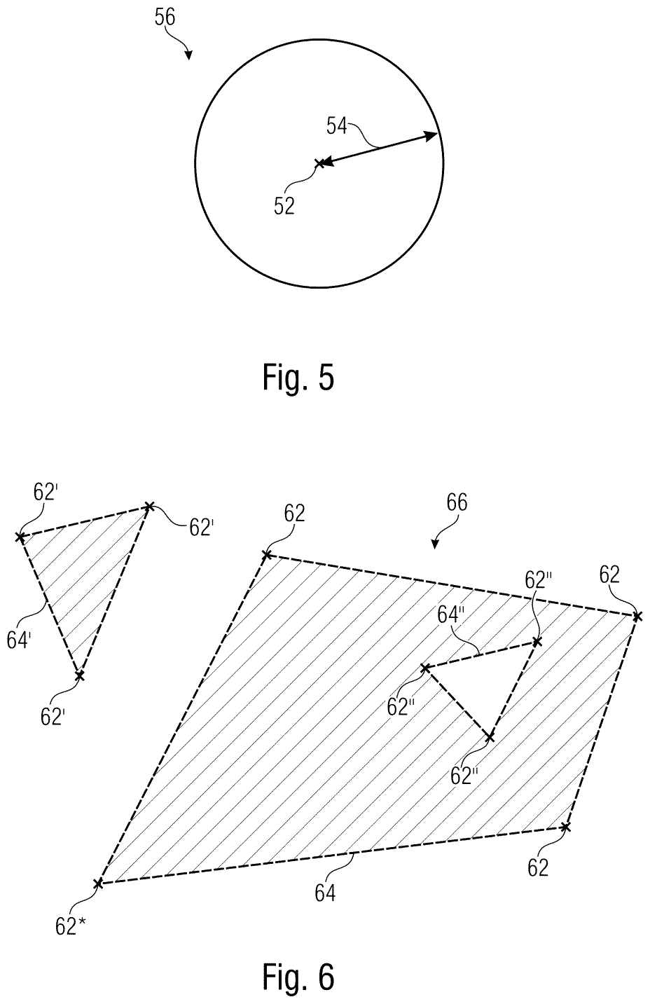

FIG. 5 illustrates an indication 56 of a geographical region according to an embodiment. According to this embodiment, the geographical region is indicated using a geographical positon 52, and radius 54 to indicate a circular region.

FIG. 6 illustrates an indication of a geographical region 66 according to an embodiment. According to this embodiment, the geographical region 66 is signaled by means of indicating a polygon 64. In the illustrative example of FIG. 6, a first polygon 64 is indicated by signaling geographical positions 62.

According to embodiments, the positions 62 defining the polygon 64 are encoded into the target group information 40 using differential coding. The differential coding allows an improved tradeoff between accuracy of the signaled positions and bitrate compared to signaling absolute coordinates of the geographical positions. For example, at least two of the at least three positions are coded differentially, e.g. the at least two positions are signaled relative to a predetermined position 64* among the at least three positions. In an alternative example, at least two of the at least three positions are coded differentially with respect to (or are signaled relative to) respective previously coded positions according to a coding order among the at least three positions.

According to embodiments, the target group information 40 indicates multiple geographical regions, which may be referred to as partial geographical regions, as exemplarily illustrated in FIG. 6 with respect to the polygon variant but being also applicable to any other form of signaling multiple region, e.g. using circles or region codes.

In the illustrative example of FIG. 6, the indication for the geographical region 66 of FIG. 6 is composed of three polygons 64, 64′, 64″, each of which is indicated using at least three geographical positions, referred to using reference signs 62, 62′, 62″ for the respective polygons. That is, multiple partial regions may be signaled. A partial geographical region falling within another partial geographical region, or overlapping with another partial geographical region, such as, for example, partial region 64″ in FIG. 6, which is located within partial region 64, may be interpreted as an exclusion from the surrounding partial geographical region. Such a region 64″ falling within another partial geographical region 64 may also be referred to as sub-region of region 64, as also described later on with respect to region codes.

In other words, the target group information 40 may comprise indications for a set of one or more partial regions to indicate the geographical region, and the target group information 40 may comprise, for one or more or all of the one or more partial regions, an indication which indicates if the partial region belongs to the geographic region 66 (such partial region being referred to as include region), or is excluded from the geographic region 66 (such partial region being referred to as exclude).

According to an embodiment, an include region is to be considered belonging to the geographical region except for a portion of the partial region, which overlaps with an exclude region signaled in the target group information. According to this embodiment, an exclude region is to be considered excluded from, i.e. not belonging to, the geographical region independent of further signaled partial regions. Accordingly, the receiver 10 is to be considered to be not located within the geographical region, if it is located within an exclude region. If the receiver 10 is located within an include region and not located within an exclude region, the receiver 10 is to be considered to be located within the geographical region.

According to another embodiment, a portion of an exclude region may be indicated to belong to the geographical region, if it overlaps with an include region. In this case, an order in the signaling of the partial regions may be used to indicate if an overlapping portion belongs to the geographical region or is to be excluded from the geographical region. For example, a partial region signaled later in the order may overrule a previously signaled partial region.

Accordingly, the target group information 40 may include, for each of the partial regions, an indication, which differentiates between the partial region to be included or excluded in the geographical region. Alternatively, the target group information 40 may merely include an indication for each partial region, which is to be excluded from the geographical region, and if such indication is absent, the receiver may infer that the partial region is to be included in the geographical region. Alternatively, the target group information 40 may merely include an indication for each partial region, which is to be included in the geographical region, and if such indication is absent, the receiver may infer that the partial region is to be excluded in the geographical region. In examples, in any case, the indication signaled for a partial region may be overruled by the signaling of a further partial region.

In other words, according to an embodiment, the receiver 10 is configured for checking, whether the target group information 40 comprises, for a partial region, e.g. a polygonal partial region, which is indicated in the target group information 40, an indication, which indicates that the partial region is to be excluded from the geometric region.

It is noted that the signalization of indications whether to include or exclude a partial region is not limited to the polygonal region signaling, but may equivalently be applied to a signaling using region codes or circular regions.

In examples, the mentioned signalizations using polygons, circles, and region codes may be combined. In particular, polygons and circles may be combined. That is, the above-mentioned partial regions may be indicated in the target group information 40 using circular and/or polygonal regions. It is noted that circular regions may be used to indicate exclude regions within polygonal regions, and polygonal regions may be used to indicate exclude regions within circular regions.

According to embodiments, referring to both examples of circular regions or regions defined by polygons, the target group information 40 further comprises a scaling factor using which geometric indications of the target group information, which indicate the geographic region, are to be scaled to obtain the geographical region from the information signal in the target group information.

It is noted that the geographical region indicated in the target group information may either define the target group in a sense that a location within the defined geographical region belongs to a target group, or in a sense that a location inside of the indicated geographical region does not belongs to the target group. According to embodiments, it is signaled in the target group information, which of the two interpretations is to be applied to derive the target group.

In the following, an exemplary implementation for signaling the target group information 40 is described. In particular, the described implementation makes use of signaling the target group information using one or more FIGS, referred to as FIG. R.

In the following, an exemplary implementation of an FIG, referred to as FIG. R, as it may be used in the context DAB/DAB+, is described. FIG. R may optionally be an example of the implementation of each of packets 42, 42′, 42″, 42″.

FIG. R may permit to restrict/regionalize the area relevant for an announcement.

An area can be described (a) by geo position and/or (b) by a region string or prefix of a region string.

A radio receiver with a GNSS receiver or any other form of location awareness can use the geographically determined geo position.

A radio receiver without position awareness can utilize user provided information (region string) for regionalization.

A region string could be for example a ZIP codes, phone area codes or similar region codings to be defined by an applicable authority within a country.

A geo position can be defined as a polygon built from at least 3 points. Alternatively (or additionally), a geo region can be described as a circle by defining latitude/longitude of the center and the radius.

This FIG. is variable size. Up to four FIGS can be used to regionalize an announcement. An exemplary sequence of bits signaled in the FIG. may be as follows:
ttii ccTT<variable size area field>

### Whereas:

tt indicates the announcement type of the currently active announcement, e.g. with the
following assignments:
00: alarm announcement,
01: OE alarm announcement
10: test alarm announcement
11: OE test alarm announcement
ii index of to up to 4 FIGS of type 0/R used for regionalization (e.g. indication 44)
cc number of FIGS of type 0/R used for regionalization minus 1 (e.g., a value “00” indicates that a single FIG. R is used) (e.g., indication 46)
TT type of restriction (TT may be omitted in examples, which support only one type of region restriction). Exemplary assignments are:
00: region string
01: circle
10: polygon
11: rfu
tt shall be set to the announcement type currently signaled by FIG. 0/18 or FIG. 0/26 (and also reflected in FIG. 0/S).

For example, all fields except for tt set to a predetermined value, e.g., ii, cc and TT set to “00”, followed by an empty “variable size area field”, may be used to indicate that the region for the indicated announcement type is not restricted and (at least) as large as the coverage area of the ensemble.

For area type “region string” (e.g., TT= “00”), the area field encodes one or multiple region strings or prefixes of region strings.

A set of one or more applicable strings to match against must be provided by the user and would typically be stored in the receiver.

For greater coding efficiency, in addition to signaling the region strings/region string prefixes included in the area, it is optionally also possible to exclude certain region strings/region string prefixes (e.g., if an emergency affects all districts of a city but one district).

Multiple region strings/region string prefixes might be carried inside the FIG.

The characters of the strings may, for example, be coded as UTF-8 characters (using code points above 0x1F), and matching shall be performed by byte-by-byte comparison, but also other implementations are feasible.

For example, the receiver shall consider itself “inside” the defined area, if any user provided region string matches any of the signaled include region strings/region string prefixes, provided that this user provided string does not also match one of the signaled exclude region strings/region string prefixes.

For example, if multiple regions string/region string prefixes are carried inside an FIG. R, they may be sorted so that the shortest region strings/region string prefixes of the affected area are listed first, separated by a NULL byte (code point 0x00). If exclude regions are used, they may also be sorted with the shortest region strings/region string prefixes first, separated by code point 0x01. Before the first exclude region string/region string prefix, code point 0x01 may be used. The exclude region strings/region string prefixes may be carried after the include region strings/region string prefixes.

Examples (assuming that only the shown FIG. R information is provided):

In this example, ZIP codes are used as region strings, however, the described scheme may also be implemented using region codes other than ZIP codes.

The user provided string (stored in the receiver) is “91058”. FIG. R encodes one or multiple ZIP codes or prefixes of ZIP codes. The receiver shall consider itself inside the area for any of the following signalled include ZIP codes as region strings: “91058”, “9105”, “910”, “91” or “9”. That is, for example, the receiver may check, whether its stored string is a sub-string of the string signaled in the FIG. R.

The user provided string (stored in the receiver) is “91056”. If FIG. R signals “9105<0x01>91056<0x01>91057”, then the receiver shall NOT consider itself inside the affected area since “91056” matches the include rule “9105”, but it also matches the exclude rule “91056”.

The user provided strings (stored in the receiver) are “91058” and “91056”. If FIG. R signals “9105<0x01>91056<0x01>91057”, then the receiver shall consider itself inside the affected area since “91058” matches the include rule “9105”, and it does not match any of the exclude rules “91056” and “91057”.

For example, if FIG. R signals “9104<0x00>9105<0x01>91052<0x01>91053”, then the receiver is inside the area, if the user provided a region string that started with “9104” or “9105”. But region strings starting with “91052” or “91053” are NOT inside the affected area.

For example, if FIG. R signals “<0x01>91054”, then almost the entire coverage area of the ensemble is affected, but not user provided region strings starting with 91054.

If many region strings/region string prefixes are used, it might be necessary to split the list into two be: FIG. R. An example with two FIG. R would
“9104<0x00>9105<0x00>9105<0x00>9107<0x00>9108” and
“<0x01>91042<0x01>91044”

Or
“<0x01>91042<0x01>91044” and
“9104<0x00>9105<0x00>9105<0x00>9107<0x01>91052”

Accordingly, as described with respect to the examples above, but being implementable irrespective of further details described with respect to FIG. R, the target group information 40 may signal one or more partial regions, and for each of the partial regions, an indication, which indicates, whether the partial region belongs to geographical region, or whether the partial region is excluded from the geographical region.

For example, a hierarchy among signaled regions may be defined, e.g., as in the above examples using region strings, by length of the string, shorter strings being of higher hierarchy. In this example, in case the target group information 40 includes two partial regions of different hierarchy, which partial regions overlap, the receiver may overrule, for the overlapping part, the indication for the partial region with higher hierarchy according to the indication for the partial region with lower hierarchy, i.e., the lower hierarchy, e.g. the longer region string or the sub-region, has priority.

In other words, according to embodiments, the target group information indicates the geographical region based on one or more region codes (e.g., string codes such as ZIP codes), wherein each of the region codes is associated with a level of a hierarchical level structure (e.g., according to a length of the respective string code). For example, a region associated with a first level of the hierarchical level structure comprises a plurality of sub-regions of a second level of the hierarchical level structure, which second level is lower than the first level, e.g., the regions and sub-regions thereof form a tree-like structure. According to this embodiment, the receiver 10 may determine the geographical region by checking whether one of the one or more region codes stored in the receiver matches one of the region codes indicated in the target group information or is indicative of a sub-region of one of the region codes indicated in the target group information. For example, in case of string codes, the receiver may perform a string comparison from the highest hierarchical level of the hierarchical structure to the lowest level of the respective region code indicated in the target group information, and if the two region codes match down to this lowest level, receiver 10 may conclude that the two regions match, e.g. that the respective region of the ones stored in the receiver is to be included or excluded in the geographical region (e.g., depending on an exclude indication).

Alternatively to the hierarchical structure, a coding order, or a priority of exclude regions as described with respect to the polygons may also be applied to region codes.

Proceeding with the description of FIG. R. a total of up to 4 FIG. 0/R can be used to provide region strings/region string prefixes (provided that no other restriction type is used, such as geo location).

For area type “circle” (e.g., TT= “01”), the area is described as center and radius of a circle.

For example, the first byte within the <variable size area field>may further specify the given area as:

### EssX XXXX

E exclude flag: if set to “1”, the receiver shall not consider itself in the area affected by the announcement if it is inside the specified circle
SS scaling. The radius shall be scaled according to this scaling factor. Exemplary assignments are:
00: no scaling
01: multiply given radius by 2
10: multiply given radius by 5
11: multiply given radius by 10
XXXXX rfa

The center is then specified as latitude/longitude (24 bits each), followed by the radius (16 bits).

For example, a latitude value may be specified as a 24-bit 2's complement integer number, in 1/92000th degrees between-90.0 degrees (south pole) and +90.0 degrees (north pole) (leading to a granularity of ca. 2,4 m). A longitude value is specified as a 24-bit 2's complement integer number, in 1/46000th degrees between-180.0 degrees (west) and +180.0 degrees (east) (leading to a minimum granularity of ca. 2,4 m). A radius is specified by a 16-bit unsigned integer number (with value>=1), specifying the radius around a latitude/longitude center point in multiples of 1 meter (for ss= “00”, no scaling), leading to a maximum radius of 655 km (for ss= “11”, multiply by 10)).

For area type “polygon” (e.g., TT= “10”), the area is described by a polygon, i.e., by a series of latitude/longitude points.

For example, the first byte within the <variable size area field>shall further specify the given area as:

### EssX XXXX

E exclude flag: if set to “1”, the receiver shall not consider itself in the area affected by the announcement if it is inside the specified polygon

SS scaling. Each encoded delta value shall be scaled according to this scaling factor (both diff_latitude and diff_longitude value). Exemplary assignments are:
00: no scaling
01: multiply by 2
10: multiply by 5
11: multiply by 10
XXXXX rfa

E.g., up to 11 points can be described per FIG. R, the resulting polygon describing the geographical region or one sub-area (e.g., partial region). For completion of the polygon, the last point of the series shall implicitly be connected with the first one.

There may be up to four polygons (potentially disconnected ‘sub-areas’ or partial regions) describing the overall relevance area, each carried in its own FIG. R.

For example, delta encoding is used. Only the starting point (“reference point”) of a polygon, e.g. of a ‘sub-area’ is encoded as an absolute latitude/longitude pair (for the encoding of an absolute latitude/longitude point see above). All following points are encoded relative to the starting point/reference point by a diff_latitude/diff_longitude pair. Alternatively, all following points are encoded relative to the preceding point by a diff_latitude/diff_longitude pair.

In example, in order to provide higher resolution for smaller distances and bigger reach for larger distances, a logarithmic scale is used to represent the delta-points. For example, very short distances are encoded with around 10 m resolution (for scaling ss= “00”), while for long distances (e.g. 540 km for scaling ss= “11”), the resolution is around 20 km.

For example, each delta-point may be encoded as a 2-byte value pair specifying the difference in degrees to the reference point. The first byte encodes the north/south difference, while the second byte encodes the west/east direction. Each value comprises a 1-bit sign and is a 7-bit table index. By using the table index, the distance in 1/46000th of a degree to the starting point/reference point is given, for example, as:

```
distance_to_reference_point_in_one_46000th_of_a_degree = (
  4, 8, 12, 17, 21, 25, 29, 33,
  37, 41, 50, 58, 66, 74, 83, 91,
  99, 107, 116, 124, 132, 140, 153, 165,
  178, 190, 202, 215, 227, 240, 252, 264,
  277, 289, 310, 331, 351, 372, 393, 413,
  434, 455, 475, 496, 537, 579, 620, 661,
  702, 744, 785, 826, 868, 909, 950, 992,
  1033, 1074, 1116, 1157, 1198, 1240, 1281, 1322,
  1364, 1405, 1488, 1570, 1653, 1736, 1818, 1901,
  1983, 2066, 2149, 2231, 2314, 2397, 2479, 2603,
  2727, 2851, 2975, 3141, 3306, 3471, 3636, 3802,
  3967, 4132, 4339, 4545, 4752, 4959, 5165, 5372,
  5785, 6198, 6612, 7025, 7438, 7851, 8265, 8678,
  9091, 9504, 9917, 10331, 10744, 11157, 11570, 12397,
  12810, 13223, 13636, 14050, 14463, 14876, 15289, 15703,
  16529, 17355, 18182, 19008, 19835, 20661, 21488, 22314
  )
```

It is noted that the granularity and the reference table are exemplary, and other implementations are feasible. Also, in examples, the signaling does not necessarily cover the entire earth surface, but may be restricted to a specific region, e.g. a broadcasting region, in which the radio signal can be received, so that a better tradeoff between preciseness and data rate may be achieved.

For example, the absolute longitude (e.g., given in 1/46000th of a degree) of such a delta-encoded point is derived by using the index value of diff_longitude to derive the distance_to_reference_point_in_one_46000th_of_a_degree for this index value. This value is then scaled according to the scaling factor of the polygon. If the sign bit is set to “0” (a positive number), then this value is added to the longitude of the reference point to derive the longitude of the delta-encoded point.

For example, the absolute latitude (e.g., given in 1/92000th of a degree) of such a delta-encoded point is derived by using the index value of diff_latitude to derive the distance_to_reference_point_in_one_46000th_of_a_degree for this index value. This value is then scaled according to the scaling factor of the polygon and multiplied by 2. If the sign bit is set to “0” (a positive number), then this value is added to the latitude of the reference point to derive the latitude of the delta-encoded point.

For example, each value of the delta-point is able to describe a distance of at most+540 km at the equator away from the reference point (for ss= “11”, multiply by 10). If this distance is not sufficient, up to three additional polygons (each in its own FIG. R) can be used to enhance the area affected by the emergency.

With this encoding, it is possible to describe every sub-area, for example, by 11 points (1 reference point plus between 2 and 10 delta-encoded pairs) per FIG. R.

In an example, a radio receiver shall consider itself “inside” the area, if the radio receiver supports a certain area type (e.g. circle or polygon area), this type is provided via FIG. R, the receiver's current position is “inside” any of the specified (sub-) areas and NOT also “inside” any of the excluded (sub-) areas.

In an example, if the radio receiver supports a certain area reference (e.g., the radio receiver is able to determine its geo position and therefore it supports both area types circle and polygon area), this area type is (or these area types are) provided via FIG. R, the receiver's current position is “inside” any of the specified (sub-) areas and NOT also “inside” any of the excluded (sub-) areas.

Note: in order to be sure that the receiver is not inside any of the excluded (sub-) areas, it may have to look at all the used FIG. R.

If a radio receiver does not support any of the area types signaled within FIG. R (or no FIG R is not provided), it shall consider itself “inside” the area by default.

It is noted, that in the description of FIG. R, implementation details such as the exact number of bits of the described fields, and the order of the fields are exemplarily, and alternatively be implemented differently. Also, the fields may in examples be implemented independently from each other. For example, the scaling factor is optional, and independently implementable of other features. Furthermore, also the exclude indication is optional, and may be implementable independent of other features. Furthermore, the label 0/R used for the described FIG. is merely exemplarily, other labels may be used.

In the following, optional functions of receiver 10, which make use of the signalization described with respect to FIGS. 1 to 6, are described.

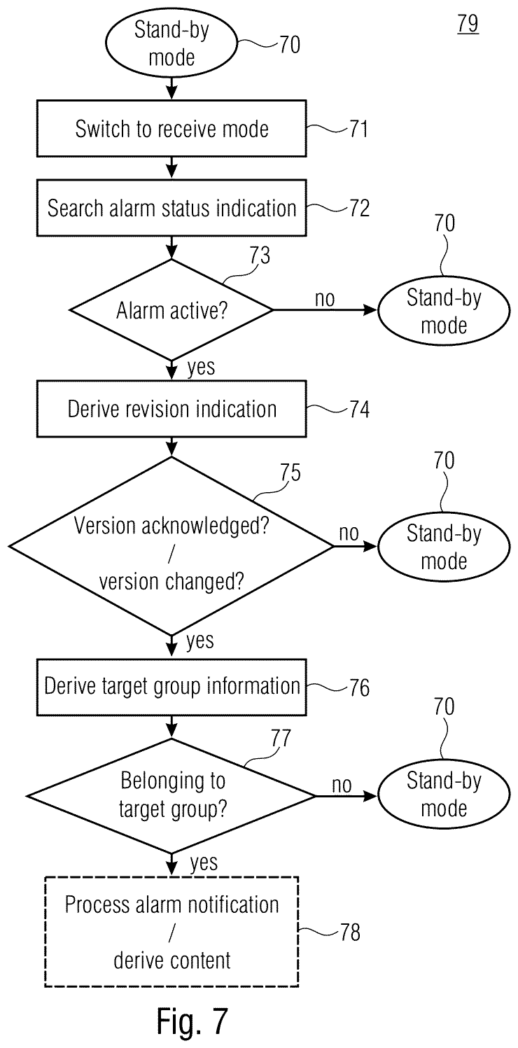

FIG. 7 illustrates a flow-chart for an operation scheme 79 of the receiver 10 according to an embodiment. According to this embodiment, receiver 10 has a stand-by operation mode 70, e.g. a low power operation mode, or a sleep operation mode. When operating in the stand-by operation mode, receiver 70 may check the presence of an active alarm announcement, e.g. periodically, e.g. once per minute, or with a periodicity in a range from 10 seconds to 2 minutes, or from 10 seconds to one minute. Receiver 10 may perform the checking for an active alarm announcement according to operation scheme 79.

In step 71, receiver 71 switches to a receiving mode, e.g. by switching on means for receiving digital radio signals. For example, receiver 10 may tune into the last received digital radio signal, or may search for a digital radio signal, in particular, for one which supports alarm announcements, as will be described in more detail with respect to FIG. 9.

In step 72, receiver 10 searches for an alarm status indication 32 in the digital radio signal 12. For example, receiver 10 scans the first channel of the digital radio signal 12 for the alarm status indication 32. For example, receiver 10 searches for the predetermined packet 36, and upon receiving the predetermined packet 36, derives alarm status indication 32 from the packet.

In step 73, if the alarm status indication 32 indicates that no alarm is active, receiver 10 switches back to stand-by mode. That is, receiver 10 switches the means for receiving digital radio signals off. Otherwise, receiver 10 processes the alarm announcement, e.g. continues with the further steps 74 following.

In step 74, receiver 10 derives the revision indication 34, e.g. from packet 36, e.g. from the same packet as the alarm status indication 32. As described above, receiver 10 may check, whether the version of the alarm announcement, or the content of the alarm announcement, to which the alarm status indication 32 refers, is the same as the version of a previously received alarm announcement, which was already acknowledged, e.g. by the user.

In step 75, if the current version is not a new version, i.e. has not changed, has already been acknowledged, receiver 10 switches back to stand-by mode. That is, receiver 10 switches the means for receiving digital radio signals off. Otherwise, receiver 10 processes the alarm announcement, e.g. continues with the further steps 76 following.

In step 76, receiver 10 derives the target group information 40 associated with the alarm status indication 32 from the digital radio signal, e.g. from the first channel 22.

In step 77, receiver 10 checks whether the receiver 10 belongs to the target group, e.g. as described above. If receiver 10 does not belong to the target group, receiver 10 switches back to stand-by mode. That is, receiver 10 switches the means for receiving digital radio signals off. Otherwise, receiver 10 processes the alarm announcement, e.g. continues with step 78, which may optionally include deriving the content associated with the alarm announcement.

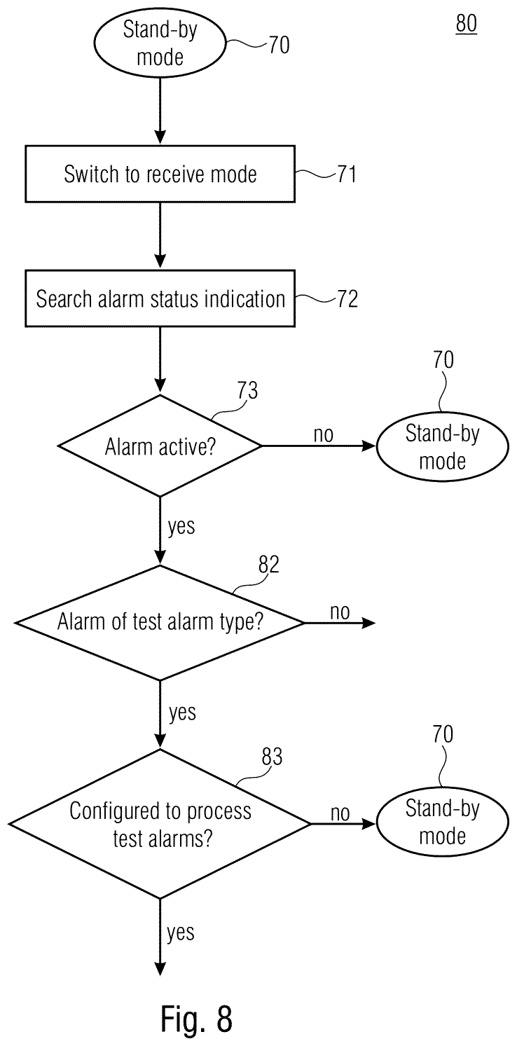

It is noted, that in the scheme 79, steps 74 and 75, as well as steps 76 and 77, as well as step 78 are optional. Also, the order of the steps is exemplary. Furthermore, the processing of the alarm announcement may depend on further conditions, e.g. the test type condition, described with respect to FIG. 8, the check for which may be integrated in scheme 79 at any position after having received the alarm status indication 32.

FIG. 8 illustrates a flow-chart for another operation scheme 80 of the receiver 10 according to an embodiment. Operation scheme 80 comprises steps 70 to 73 of operation scheme 79.

Operation scheme further comprises step 82, which is invoked if step 73 yields that there is an active alarm announcement. In step 82, receiver 10 checks if the active alarm announcement is of the test type. If so, receiver 10 check, in step 83, whether receiver 10 is, according to a configuration information stored in a storage medium of receiver 10, configured to process test alarms. If not, receiver 10 switches back to stand-by mode.

Otherwise, receiver 10 processes the alarm announcement, e.g. continues with any of steps 74, 76, or 78 according to a processing order of these steps or a subset thereof. That is, steps 82 and 83 may be integrated in operation scheme 79 at any position. Similarly, if step 82 yields that the alarm is not of a test alarm type, receiver 10 may proceed with any of steps 74, 76, or 78 according to a processing order of these steps or a subset thereof.

FIG. 9 illustrates an operation scheme 90 of the receiver 10 according to an embodiment. Operation scheme 90 uses the support indication 38 to check, whether a digital radio signal supports a signalization of alarm status indication 32. According to operation scheme 90, receiver 10 checks in a step 92, whether a currently used digital radio signal 12 supports the signalization of an alarm status indication 32. To this end, receiver 10 may search for the support indication 38, e.g., by searching for the packet 36 in the first channel of the current digital radio signal, and may check the support indication 38. For example, receiver 10 may perform step 92 upon initiating the stand-by mode 70. In examples, in which the alarm status indication 32 indicates the alarm status for the set of alarm types, the check of step 92 may refer to one or more specific alarm types, e.g. non-test-type alarm types only, i.e. receiver 10 may check, whether the radio signal supports signalization of an alarm status indication for a non-test alarm type. If the current radio signal supports the alarm status indication, receiver 10 may optionally proceed with operation scheme 79, otherwise with step 93.

In step 93, receiver 10 searches for a digital radio signal, which supports alarm status notifications, e.g. by scanning available digital radio signals for the alarm status indication 32, until finding a digital radio signal supporting alarm status indications, e.g. for a specific alarm type, e.g. non-test alarm types.

According to step 94, if receiver 10 found a radio signal supporting the alarm status indication, receiver 10 may optionally proceed with operation scheme 79, otherwise receiver 10 may, when operating in the stand-by mode, refrain from searching for alarm status indications, e.g., refrain from switching to the receive mode. In examples, receiver 10 may periodically wake up for checking, whether a digital radio signal supporting alarm status indication is available.

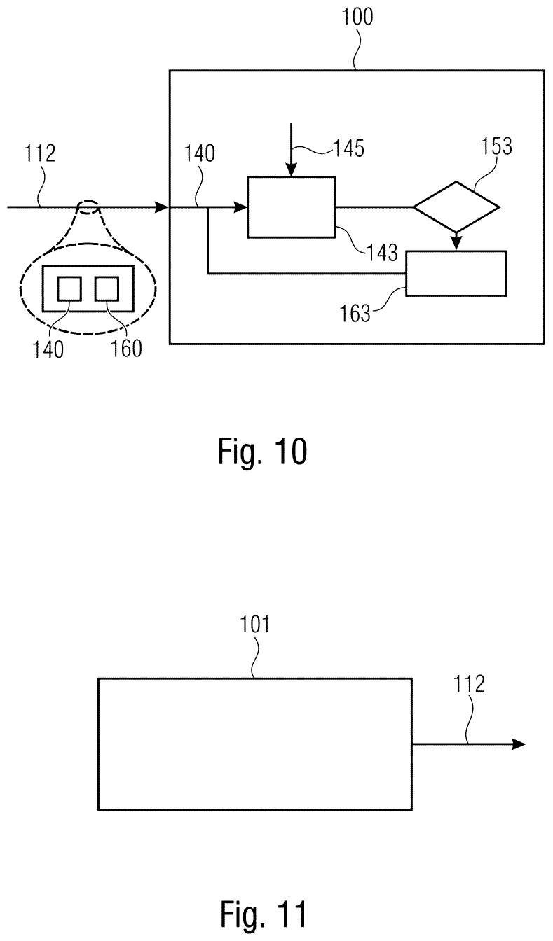

FIG. 10 illustrates an apparatus 100 for receiving a digital radio signal 112 according to an embodiment. Apparatus 100 may be referred to as receiver 100. The digital radio signal 112 comprises content information 160 and a target group information 140, which indicates a geographical region for which the content information 160 is dedicated. Apparatus 100 derives the target group information 140 from the digital radio signal 112, and compares, using module 143, an information about a geographic location 145 of the apparatus with the target group information 140 to determine whether the apparatus is, according to the information about a geographic location, located within the geographical region. According to decision module 153, if the apparatus is, according to the information about a geographic location, not located within the geographical region, apparatus 100 refrains from processing the content information 160. For example, otherwise, i.e., if the apparatus is, according to the information about a geographic location, located within the geographical region, apparatus 100 processes, or considers a processing of, the content information using processing module 163. The target group information 140 is indicative of at least three geographical positions forming a polygon to indicate the geographical region, wherein the apparatus is configured for using differential decoding for deriving the geographical positions from the target group information.

In other words, the geographical region may indicate a target group for the content information 160 in terms that a receiver being located within the geographical region may belong to the target group. The content may relate to alarm signals, as described before, but may also relate to other regionalized content, such as advertisement. Based on the target group information, receiver 100 may recognize, whether it belongs to the target group of the content information 160.

Accordingly, the target group information 140 may be associated with the content 140, and the digital radio signal may include further content information 140, which may be associated with a further target group signaled by further target group information.

It is noted that, for example, receiver 100 does not necessarily process the content information 160 if receiver 100 belongs to the target group, but the processing may optionally depend on further conditions, i.e. receiver 100 considers processing the content information if receiver 100 belongs to the target group.

For example, the signalization of the target group information 140, or the geographical region, may correspond to the target group information 40 described before, or may be signaled as described with respect to the target group information 40. The digital radio signal 112 may be of the type as described for the digital radio signal 12, but signal 112 does not necessarily include the alarm status indication 32. In particular, details and advantages of the differential coding of the geographical positions for the polygon described with respect to target group information 40, e.g., with respect to FIG. 6, may optionally also apply to the target group information 140.

For example, apparatus 100 receives the digital radio signal 112 via an antenna, or via cable, or via the Internet. In examples, apparatus 100 may comprise means such as an antenna and/or a demultiplexer for receiving the digital radio signal.

FIG. 11 illustrates an apparatus 101 for providing a digital radio signal 112 according to an embodiment. The digital radio signal 112 provided by apparatus 101 may correspond to the digital radio signal 112 as described with respect to the receiver 100 of FIG. 10. Accordingly, apparatus 101 is configured for providing the content information 160 and the target group information 140 in the digital radio signal 112.

For example, apparatus 101 provides the digital radio signal via an antenna, or via cable, or via the Internet. In examples, apparatus 101 may comprise means such as an antenna and/or a multiplexer for providing the digital radio signal, e.g., a DAB or DAB+multiplexer.

Features of the apparatus 100 may also be understood as features of the apparatus 101 in a sense that apparatus 101 is configured for providing the digital radio signal 112.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus. In particular, it is noted, that FIGS. 1, 2, 10, and 11, describing apparatuses, may also be regarded as representing block diagrams of corresponding methods. For example, the processing steps described with respect to apparatuses 10, 11, 100, 101 may be regarded as steps of corresponding methods.

Some or all of the method steps may be executed by (or using) a hardware apparatus, like for example, a microprocessor, a programmable computer or an electronic circuit. In some embodiments, one or more of the most important method steps may be executed by such an apparatus.

The inventive radio signal can be transmitted on a transmission medium such as a wireless transmission medium or a wired transmission medium.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example.

Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Apparatus for receiving a digital radio signal, the digital radio signal comprising a first channel for carrying side information, and a second channel for carrying content information, the apparatus being configured for deriving, from the first channel, an alarm status indication, which indicates whether an alarm announcement is active or inactive.

2. Apparatus according to claim 1, configured for retrieving the alarm status indication from a predetermined packet included in the first channel.

3. Apparatus according to claim 1, wherein the alarm status indication comprises an indicator having a first state and a second state, the first state indicating that the alarm announcement is active, and the second state indicating that the alarm announcement is inactive.

4. Apparatus according to claim 1, wherein the apparatus is configured for suppressing a processing of the alarm announcement, if the alarm status indication indicates that the alarm announcement is inactive.

5. Apparatus according to claim 1, wherein a content related to the alarm announcement is carried in a predetermined service component of the second channel, or in a predetermined service component of a further digital radio signal.

6. Apparatus according to claim 5, wherein the apparatus is configured for initiating a presentation of the content carried in the predetermined service component if the alarm status indication indicates that the alarm announcement is active.

7. Apparatus according to claim 1, having a stand-by operation mode, in which a reception of digital radio signals is switched off, wherein the apparatus is configured for, when operating in the stand-by operation mode,
switching to a receiving mode, in which the apparatus is configured to receive digital radio signals,
scanning the digital radio signal for the alarm status indication, and
checking, whether the alarm status indication indicates that the alarm announcement is active, and
if the alarm status indication indicates that no alarm announcement is active, switching back to the stand-by mode.

8. Apparatus according to claim 1, wherein the alarm status indication indicates whether one of a set of alarm types is active, or whether all of the alarm types are inactive.

9. Apparatus according to claim 8, wherein the set of alarm types comprises one or more or all of
a first alarm type, which relates to an alarm announcement, the content of which is signaled in a predetermined service component of the second channel of the digital radio signal,
a second alarm type, which relates to an alarm announcement, the content of which is signaled in a predetermined service component of a further digital radio signal,
a third alarm type, which relates to an alarm announcement of a test type, the content of which is signaled in a predetermined service component of the second channel of the digital radio signal,
a fourth alarm type, which relates to an alarm announcement of a test type, the content of which is signaled in a predetermined service component of a further digital radio signal.

10. Apparatus according to claim 8, wherein the set of alarm types comprises an alarm type referring to an alarm announcement of a test type, wherein the apparatus comprises a storage medium having stored thereon a configuration information which indicates whether to process or not to process the processing of alarm announcements of the test type, and wherein the apparatus has a stand-by operation mode, in which a reception of digital radio signals is switched off, wherein the apparatus is configured for, when operating in the stand-by operation mode, switching to a receiving mode, in which the apparatus is configured to receive digital radio signals,
scanning the digital radio signal for the alarm status indication, and
checking, whether the alarm status indication indicates that the alarm announcement is active, and
if the configuration information indicates whether to process or not to process the processing of alarm announcements of the test type, and if the alarm status indication indicates that no alarm announcement is active, switching back to the stand-by mode.

11. Apparatus according to claim 1, wherein the first channel further comprises a revision indicator, which indicates a version of a content associated with the alarm announcement.

12. Apparatus according to claim 1, wherein the first channel further comprises an indication, which indicates whether the digital radio signal supports a signalization of the alarm status indication.

13. Apparatus according to claim 12, wherein the first channel further comprises an indication, which indicates whether the digital radio signal supports a signalization of the alarm status indication, and wherein the apparatus has a stand-by operation mode, in which a reception of digital radio signals is switched off, wherein the apparatus is configured for,
when switching to the stand-by mode, checking, if a digital radio signal is available, which supports a signalization of the alarm status indication, and
wherein the apparatus is configured for, when operating in the stand-by mode,
selectively, if a digital radio signal is available, which supports a signalization of the alarm status indication,
scanning the digital radio signal, which supports a signalization of the alarm status indication, for the alarm status indication, and
checking, whether the alarm status indication indicates that the alarm announcement is active, and
if the alarm status indication indicates that no alarm announcement is active, switching back to the stand-by mode.

14. Apparatus according to claim 1, configured for if the alarm status indication indicates that the alarm announcement is active, deriving, from the digital radio signal, a target group information which indicates a property for specifying a target group for the alarm announcement.

15. Apparatus according to claim 14, configured for retrieving the target group information from a further predetermined packet of the first channel.

16. Apparatus according to claim 14, configured for
comparing the target group information to an information about the apparatus so as to determine, whether the apparatus belongs to a target group of the alarm announcement, and
processing the alarm announcement, if the apparatus belongs to the target group of the alarm announcement, and
suppressing the processing of the alarm announcement, if the apparatus does not belong to the target group of the alarm announcement.

17. Apparatus according to claim 1, configured for if the alarm status indication indicates that the alarm announcement is active, deriving, from the digital radio signal, a target group information which indicates a geographical region to which the alarm announcement relates.

18. Apparatus according to claim 17, configured for retrieving the target group information from a further predetermined packet of the first channel.

19. Apparatus according to claim 17, configured for
comparing the target group information to an information about the apparatus so as to determine, whether the apparatus belongs to a target group of the alarm announcement, and
processing the alarm announcement, if the apparatus belongs to the target group of the alarm announcement, and
suppressing the processing of the alarm announcement, if the apparatus does not belong to the target group of the alarm announcement.

20. Apparatus according to claim 17, wherein the target group information indicates the geographical region based on
one or more region codes,
one or more postal codes, or
one or more a phone area codes, or
geographical coordinates.

21. Apparatus according to claim 17, wherein the target group information indicates the geographical region based on one or more region codes, wherein each of the region codes is associated with a level of an hierarchical level structure, wherein a region associated with a first level of the hierarchical level structure comprises a plurality of sub-regions of a second level of the hierarchical level structure, which second level is lower than the first level, wherein the apparatus comprises a storage medium storing one or more region codes, and wherein the apparatus is configured for checking whether one of the one or more region codes stored in the storage medium matches one of the region codes indicated in the target group information or is indicative of a sub-region of one of the region codes indicated in the target group information.

22. Apparatus according to claim 17, wherein the geographical region is circular, and wherein the target group information is indicative of a geographical position, and a radius to indicate the geographical region.

23. Apparatus according to claim 17, wherein the target group information is indicative of at least three geographical positions forming a polygon to indicate the geographical region.

24. Apparatus according to claim 23, wherein the target group information comprises geographical coordinates for a first of the at least three geographical positions, and wherein the apparatus is configured for using differential decoding for deriving the geographical positions from the target group information.

25. Apparatus for receiving a digital radio signal, configured for deriving, from the digital radio signal, a target group information which indicates a geographical region,
comparing an information about a geographic location of the apparatus with the target group information to determine whether the apparatus is, according to the information about a geographic location, located within the geographical region,
if the apparatus is, according to the information about a geographic location, located within the geographical region, refraining from processing a content information signaled in the digital radio signal,
wherein the target group information is indicative of at least three geographical positions forming a polygon to indicate the geographical region, wherein the apparatus is configured for using differential decoding for deriving the geographical positions from the target group information.

26. Apparatus according to claim 22, wherein the target group information is indicative of a scaling factor, and wherein the apparatus is configured for deriving the geographical region using the scaling factor

27. Apparatus according to claim 17, wherein the target group information is indicative of a set of one or more partial regions, and, wherein the target group information indicates, for one or more or each of the partial regions, whether the partial region is to be included in the geographical region, or to be excluded from the geographical region, and wherein the apparatus is configured for deriving the geographical region based on the set of one or more partial regions.

28. Apparatus for providing a digital radio signal, the digital radio signal comprising a first channel for carrying side information, and a second channel for carrying content information, the apparatus being configured for providing, in the first channel, an alarm status indication, which indicates whether an alarm announcement is active or inactive.

29. Apparatus for providing a digital radio signal, configured for
providing, in the digital radio signal,
content information, and
a target group information, which indicates a geographical region for which the content information is dedicated,
wherein the target group information is indicative of at least three geographical positions forming a polygon to indicate the geographical region, wherein the apparatus is configured for using differential coding for providing the geographical positions in the target group information.

30. Method for receiving a digital radio signal, so that the digital radio signal comprises a first channel for carrying side information, and a second channel for carrying content information, the method comprising:
deriving, from the first channel, an alarm status indication, which indicates whether an alarm announcement is active or inactive.

31. Method for receiving a digital radio signal, comprising deriving, from the digital radio signal, a target group information which indicates a geographical region,
comparing an information about a geographic location with the target group information to determine whether the geographic location is, according to the information about a geographic location, located within the geographical region, and
if the geographic location is, according to the information about a geographic location, located within the geographical region, refraining from processing a content information signaled in the digital radio signal,
wherein the target group information is indicative of at least three geographical positions forming a polygon to indicate the geographical region, wherein the method comprises using differential decoding for deriving the geographical positions from the target group information.

32. Method for providing a digital radio signal so that the digital radio signal comprises
a first channel for carrying side information, and a second channel for carrying content information, the method comprising:
providing, in the first channel, an alarm status indication, which indicates whether an alarm announcement is active or inactive.

33. Method for providing a digital radio signal, the method comprising:
providing, in the digital radio signal,
content information, and
a target group information, which indicates a geographical region for which the content information is dedicated,
wherein the target group information is indicative of at least three geographical positions forming a polygon to indicate the geographical region, wherein the method comprises using differential coding for providing the geographical positions in the target group information.

34. A non-transitory digital storage medium having a computer program stored thereon to perform the method according to claim 30 when said computer program is run by a computer.

35. Digital radio signal, comprising
a first channel for carrying side information, and
a second channel for carrying content information,
wherein the first channel comprises an alarm status indication, which indicates
whether an alarm announcement is active or inactive.

36. Digital radio signal, comprising:
content information, and
a target group information, which indicates a geographical region for which
the content information is dedicated,
wherein the target group information is indicative of at least three geographical positions forming a polygon to indicate the geographical region, wherein the at least three geographical positions are coded into the digital radio signal using differential coding.
